(19) United States
(12) Patent Application Publication
(10) Pub. No.: US 2025/0141197 A1
(43) Pub. Date: May 1, 2025

(54) Tool, Machine Tool System, and Method of Operating the Tool

(71) Applicant: Robert Bosch GmbH, Stuttgart (DE)

(72) Inventors: Andreas Schlegel, Leinfelden-Echterdingen (DE); Fritz Schlegel, Stuttgart (DE); Mario Ebel, Stuttgart (DE); Timo Bayha, Wolfschlugen (DE)

(21) Appl. No.: 18/920,149

(22) Filed: Oct. 18, 2024

(30) Foreign Application Priority Data
Oct. 25, 2023 (DE) 10 2023 210 532.2

(51) Int. Cl. H02G 1/12; B25F 5/00

(52) U.S. Cl. CPC H02G 1/1246; B25F 5/001; H02G 1/1224; H02G 1/1226

(57) ABSTRACT

A tool for stripping a cable, with a cutting unit for cutting a sheath of the cable, with an alignment unit for aligning the cable for a cutting operation using the cutting unit and with a base body unit on which the alignment unit and the cutting unit are arranged. The alignment unit is configured to be adjustable to accommodate different cable diameters.

This application claims priority under 35 U.S.C. § 119 to patent application no. DE 10 2023 210 532.2, filed on Oct. 25, 2023 in Germany, the disclosure of which is incorporated herein by reference in its entirety.

### BACKGROUND

A tool for stripping a cable, with a cutting unit for cutting a sheath of the cable, with an alignment unit for aligning the cable for a cutting operation using the cutting unit and with a base body unit on which the alignment unit and the cutting unit are arranged, has already been proposed.

### SUMMARY

The disclosure proceeds from a tool for stripping a cable, with a cutting unit for cutting a sheath of the cable, with an alignment unit for aligning the cable for a cutting operation by way of the cutting unit and with a base body unit on which the alignment unit and the cutting unit are arranged.

It is proposed that the alignment unit be adjustable to accommodate different cable diameters. Due to the configuration of the tool according to the disclosure, different cables can be stripped with particular precision. A particularly flexible tool for the stripping of cables can be provided. A particularly high level of user comfort can be achieved. Advantageously, an improper stripping of cables can be counteracted particularly reliably.

It is contemplated that the tool may be configured as a stand-alone tool for stripping cables. Alternatively, it is contemplated that the tool may be configured as an insertion tool, in particular as an attachment, for a machine tool, preferably a manual machine tool.

The alignment unit is preferably intended for centering the cable, in particular with respect to the cutting unit. The term “intended” should be understood to mean specifically configured, specifically designed, and/or specifically equipped. An object being “intended” for a specific function is understood to mean that the object fulfills and/or performs this specific function in at least one application and/or operating state. The alignment unit preferably comprises at least one alignment element, preferably a plurality of alignment elements. The at least one alignment element is preferably mounted on the base body unit. The at least one alignment element is, in particular, movable relative to the base body unit, preferably for adjusting the alignment unit to adapt to different cable diameters. The alignment element is configured as a press jaw or the like. The alignment unit is preferably arranged symmetrically about an alignment axis of the alignment unit. The alignment axis in particular extends at least substantially parallel to an axis of rotation of the cutting unit. “Substantially parallel” can be understood here to mean an alignment of a direction relative to a reference direction, in particular in a plane, wherein the direction has a deviation relative to the reference direction that is in particular less than 8°, advantageously less than 5° and particularly advantageously less than 2°. Preferably, the axis of rotation corresponds to the alignment axis. Preferably, a minimum distance of the alignment unit, in particular the at least one alignment element, is adjustable relative to the axis of rotation and/or the alignment axis. The alignment unit is preferably adjustable to a minimum cable diameter of 8 mm, preferably 10 mm, preferably 15 mm. Alternatively, however, it is also contemplated that the alignment unit is adjustable to a minimum cable diameter that is less than 10 mm and/or to a maximum cable diameter that is greater than 120 mm. The alignment unit is preferably adjustable to a maximum cable diameter of 60 mm, preferably 120 mm. It is contemplated that the alignment unit may be continuously variable and/or adjustable in stages. It is contemplated that the alignment unit may be automatically and/or manually adjustable. For example, the alignment unit includes an alignment setting element for adjusting the alignment unit by an operator. The alignment setting element can, e.g., be designed as a button, a rotary wheel, a lever, or the like.

The base body unit is in particular configured as a housing. The base body unit preferably comprises a tool head. The tool head is configured to be annular or tubular, for example. However, it is alternatively also conceivable that the tool head has a different shape, in particular a shape different from a tubular shape or a ring shape, which appears to be useful to a person skilled in the art. The base body unit, in particular the tool head, in particular comprises a receiving area for a cable. The receiving area is preferably at least partially abutted by the tool head. The receiving area is preferably arranged on an inner side of the tool head. The tool head preferably comprises a bore, which in particular corresponds to the receiving area. The alignment unit, in particular the at least one alignment element and/or the cutting unit, in particular at least one cutting element of the cutting unit, are arranged on a side of the tool head facing the bore and/or the receiving area.

The cutting unit comprises the at least one cutting element for cutting the sheath. The cutting element may be formed as a blade or as a planer. The cutting unit is preferably adjustable to accommodate different cable diameters. The cutting unit, preferably the cutting element, is arranged in particular at a distance from the alignment unit, preferably the alignment element. The at least one cutting element is preferably mounted on the base body. The at least one cutting element is particularly movable relative to the base body unit, preferably for adjusting the cutting unit to adapt to different cable diameters. Alternatively, it is also conceivable that the cutting unit, in particular the cutting element, is arranged on the alignment unit, preferably on the alignment element, in particular mounted on the alignment unit, preferably on the alignment element, preferably for adjustment to different cable diameters. Preferably, a minimum distance of the cutting unit, in particular the at least one cutting element, is adjustable relative to the axis of rotation and/or the alignment axis. The cutting unit is preferably automatically adjustable, in particular by way of a sensor unit, and/or manually adjustable. For example, the cutting unit comprises a cutting unit setting element for adjustment of the cutting unit by an operator. The cutting unit setting element can, e.g. be designed as a button, a rotary wheel, a lever, or the like. For example, the sensor unit comprises at least one of a tactile sensor, an optical sensor, or another sensor that appears useful to a person skilled in the art for automatically adjusting the cutting unit and/or the alignment unit.

Preferably, the cutting unit is configured such that the cutting unit interrupts the cutting process upon reaching a predefined stripping distance. It is contemplated that the cutting unit has a control unit for measuring the stripping distance, for example a mechanical, electronic and/or optical control unit. The stripping distance is pre-determined, for example by way of a cable stop of the tool, in particular the control unit. It is contemplated that the stripping distance is predetermined by the control unit. It is also contemplated that the cutting unit controls the cutting process, in particular interrupting the process, as a function of measurements taken using the control unit. Further, it is contemplated that the control unit is configured to sense an electrical voltage of the cable being stripped and preferably to issue a warning to an operator, for example via an output unit of the tool. It is also contemplated that the control unit is intended to determine a distance of the cutting unit to the cable, wherein, in particular, an adjustment of the cutting unit can be carried out and/or a notice can be issued to the operator, for example via the output unit.

Preferably, the tool, in particular the cutting unit and/or the alignment unit, can be driven by a drive unit of the manual machine tool, in particular in a state connected with the manual tool machine. Alternatively, it is also conceivable that the tool configured, in particular as a separate tool, comprises a drive unit for driving the cutting unit and/or the alignment unit. The drive unit preferably has an electric motor or the like. In particular, the drive unit is intended for driving a cutting process when stripping a cable using the cutting unit. In addition, it is contemplated that the power unit is intended for an adjustment of the cutting unit, preferably automatically, depending on the sensor unit and/or the control unit. It is contemplated that the control unit is at least partially formed by the sensor unit, preferably that it is a part of the sensor unit. The drive unit is particularly provided to drive the cutting unit about the axis of rotation, in particular a rotation of the cutting unit, in particular the at least one cutting element to generate the axis of rotation, preferably relative to the base body unit, in particular the tool head, preferably for performing a cutting operation.

In addition, it is proposed that an adjustment of the alignment unit is coupled to an adjustment of the cutting unit. Advantageously, an adjustment of the cutting unit may be automatically adapted to an adjustment of the alignment unit. A particularly high level of user comfort can be achieved in an advantageous manner. Particularly reliable cable stripping can be achieved. An unintended maladjustment of the cutting unit and/or the alignment unit may be counteracted. It is contemplated that the adjustment of the alignment unit may be mechanically, electronically, electrically, and/or wirelessly coupled to the adjustment of the cutting unit. In particular, the adjustment of the cutting unit is dependent on the adjustment of the alignment unit. Preferably, an adjustment of the cutting unit can be triggered by an adjustment of the alignment unit.

It is further proposed that the alignment unit is provided for an independent, in particular automatic, adjustment to a cable diameter of a cable. Advantageously, proper adjustment of the alignment unit may be supported. A particularly simple and/or precise stripping of a cable may be supported. User comfort may be increased. It is contemplated that the tool for automatic adjustment of the alignment unit comprises the sensor unit. Preferably, the drive unit is provided for adjustment of the alignment unit, preferably automatic adjustment, preferably depending on the sensor unit and/or the control unit.

In addition, it is proposed that the tool comprises at least one spring element, wherein the alignment unit is at least partially connected to the base body unit via the spring element, in particular being spring-mounted on the base body unit. A cable may be prevented from becoming stuck in the tool. Advantageously, a particularly high level of reliability can be realized. Advantageously, a particularly high level of user comfort can be achieved. In particular, the alignment element is connected to the base body unit via the spring element, preferably being spring-mounted on the base body unit. A spring-acting alignment of a cable can in particular be achieved by the spring element by way of the alignment unit. Preferably, the spring element is operatively disposed between the at least one alignment element and the base body unit. For example, the spring element is configured as a spring, in particular as a spiral spring, as a torsion spring, as a leg spring, as a leaf spring, as a rubber elastic element or the like. Alternatively or additionally, it is also conceivable that a further spring element of the alignment unit is disposed on the at least one alignment element on a side facing the alignment axis, which preferably abuts the cable, preferably in at least one operating state, in particular a cable alignment state.

It is further proposed that the tool comprises a display unit for displaying an adjustment of the alignment unit. Advantageously, the adjustment of the alignment unit can be checked particularly easily and/or conveniently. Advantageously, a misalignment of the alignment unit can be particularly easily and/or effectively countered. The display unit may be configured as a mechanical display, an electromechanical display, an electrical display, an electronic display, or the like, or as a combination thereof. The display unit is preferably arranged on an outer side of the base body unit, in particular the tool head. It is contemplated that the display unit is part of the output unit, in particular formed by the output unit.

In one aspect of the disclosure, which can in particular be considered independently of further aspects of the disclosure, it is proposed that the cutting unit has at least one cutting element, in particular the cutting element specified hereinabove, the cutting angle of which is adjustable. Advantageously, a particularly flexible and/or adjustable cutting unit can be provided. The cutting angle of the at least one cutting element is adjustable, for example, to carry out a spiral, a round and/or longitudinal cut. Preferably, the cutting angle is adjustable with respect to the alignment axis and/or the axis of rotation, in particular movable.

In an aspect of the disclosure, which can be considered in particular independently of further aspects of the disclosure, it is proposed that the tool comprises a sensor unit, in particular the sensor unit specified hereinabove, for sensing at least one process characteristic when stripping the cable. Advantageously, a stripping process may be monitored. A quality inspection of a stripping process may be facilitated. Determination of an improper stripping of a cable may be enabled. A functionality of the tool may be monitored. For example, the sensor unit comprises an accelerometer and/or a gyro sensor. The process characteristic preferably comprises at least an acceleration characteristic. The sensor unit is provided to determine a hazardous situation as a function of the process characteristic. For example, the sensor unit is configured to detect a tilting of the cutting unit and/or an unintended rotational movement of the tool as a function of the process characteristic, in particular the acceleration characteristic. It is contemplated that the tool may include a control and/or regulation unit for controlling and/or regulating the alignment unit and/or the cutting unit, in particular the drive unit of the manual machine tool and/or the tool, respectively. It is also contemplated that the alignment unit and/or the cutting unit may be controllable and/or able to be regulated by way of a control and/or regulation unit of the manual machine tool. In particular, the control or regulation unit comprises at least one processor and one memory element, as well as an operating program stored on the memory element. The memory element is preferably designed as a digital storage medium, e.g., a hard disk or the like. It is contemplated that the control and/or regulation unit is provided to control and/or regulate the alignment unit and/or the cutting unit, in particular the drive unit, depending on the process characteristic, preferably in a cutting process via the cutting unit and/or in an alignment process via the alignment unit. For example, it is contemplated that the control and/or regulation unit is provided to adjust a rotation rate of the cutting unit, switch off the drive unit or the like, depending on the process characteristic. It is also contemplated that the control and/or regulation unit is provided to determine a quality characteristic with respect to the stripping process, depending on the process characteristic. It is contemplated that the tool will comprise an output unit, for example a display or the like, in particular the one specified hereinabove. Preferably, the control and/or regulation unit is connected to the output unit via a data link. For example, the quality characteristic and/or the process characteristic can be output to an operator via the output unit. Alternatively or additionally, it is contemplated that the manual machine tool may have an output unit for outputting the quality characteristic and/or the process characteristic.

In one aspect of the disclosure, which can in particular be considered independently of further aspects of the disclosure, it is proposed that the cutting unit is operable in a soft mode. Advantageously, a particularly clean, in particular fray-free and/or tear-free, cut of the sheath can be achieved. A particularly high quality of a cable stripping may be achieved. The soft mode preferably comprises a soft start and/or a soft shutdown. The soft start is in particular active when cutting the sheath using the cutting unit. For example, a rotational rate of the cutting unit in the soft mode, particularly during the soft start, is reduced relative to a rotational rate in the normal mode. It is contemplated that a rotational rate of the cutting unit may be continuously increased, preferably continuously or in stages, during the soft start. It is contemplated that a rotation rate in the soft shutdown will be increased briefly, in particular relative to a rotation rate in normal mode. A particularly tear-free and/or fray-free sheath end can thus be achieved.

In one aspect of the disclosure, which can in particular be considered independently of further aspects of the disclosure, it is proposed that the cutting unit is operable in two directions of rotation. Advantageously, the cutting unit can be used particularly flexibly. In terms of design technology, a particularly high degree of flexibility can be facilitated. In particular, the cutting unit is operable in two directions of rotation with respect to the axis of rotation. The directions of rotation are preferably opposite to one another. The cutting unit is in particular configured to cut the sheath of the cable in both directions of rotation.

In addition, it is proposed that the cutting unit is configured, in particular provided, to execute at least two different cutting profiles. Advantageously, the cutting unit can be used particularly flexibly. The cutting unit is particularly configured to produce a first cutting profile in one direction of rotation of the directions of rotation. The cutting unit is particularly configured to produce a second cutting profile in a further direction of rotation of the directions of rotation, which is preferably opposite to the direction of rotation. The first cutting profile is in particular different from the second cutting profile. The cutting profile can in particular be a round cut, a spiral cut, a longitudinal cut or the like. For example, the first cutting profile is a round cut. For example, the second cutting profile is a spiral cut. It is contemplated that the at least one cutting element is configured as a two-sided cutting element. A first cutting side of the two-sided cutting element is in particular configured and/or arranged to produce the first cutting profile, in particular a round cut. The first cutting profile, in particular the round cut, can be produced by the first cutting side by rotation of the cutting unit, preferably relative to the base body unit and/or the cable, in the direction of rotation. A second cutting side of the two-sided cutting element is preferably configured and/or arranged to produce the second cutting profile, in particular to strip the sheath, preferably to produce a spiral cut. By rotation of the cutting unit, preferably relative to the base body unit and/or the cable, in the further direction of rotation, the second cutting profile, in particular the spiral cut, can be produced by the second cutting side. Alternatively, it is conceivable that the cutting element is configured and/or arranged such that a cut of the sheath by the cutting element is only possible in the direction of rotation through a rotation of the cutting unit, preferably relative to the base body unit and/or the cable. The cutting unit comprises, e.g., at least one further cutting element. The further cutting element is preferably configured and/or arranged such that a cut of the sheath by the further cutting element is only possible in the further direction of rotation by rotation of the cutting unit, preferably relative to the base body unit and/or the cable. The tool preferably comprises an operating element for switching the direction of rotation. The operating element is preferably configured as a button, a lever, a knob, or the like. However, it is also contemplated that the direction of rotation may be automatically switchable during a cutting operation, for example by way of the control and/or regulation unit.

In one aspect of the disclosure, which can in particular be considered independently of further aspects of the disclosure, it is proposed that the tool comprises a lighting unit to illuminate a cutting area of the cutting unit. Advantageously, a stripping process can be monitored particularly easily and/or efficiently. An alignment of the cable by way of the alignment unit can be checked particularly easily and/or effectively. Particularly comfortable and/or reliable cable stripping may be supported. For example, the lighting unit comprises at least one lighting element, preferably a plurality of lighting elements. The lighting element is preferably configured as an LED or the like. The lighting unit is preferably arranged on a side of the base body unit facing the alignment axis, in particular the tool head, preferably on the inner side.

In one aspect of the disclosure, which can in particular be considered independently of further aspects of the disclosure, it is proposed that the tool comprises a removable cable top, in particular the one specified hereinabove. Advantageously, the tool can be used particularly flexibly. Advantageously, the use of a cable stop can be omitted. The cable stop is in particular attachable to the base body unit, preferably to the tool head, in such a manner that it can be released. The cable stop is preferably configured to be adjustable, in particular manual and/or automatic. It is contemplated that the cable stop may include an indicator for reading an adjustment of the cable stop. Alternatively, it is contemplated that an adjustment of the cable stop may be able to be output via the output unit of the manual machine tool and/or the tool. In particular, a maximum stripping distance, in particular parallel to the alignment axis, is adjustable via the cable stop.

Further, a machine tool system is proposed having a manual machine tool, in particular the manual machine tool specified hereinabove, and the tool attachable to the manual machine tool. A machine tool system may be provided that allows for particularly flexible and/or reliable cable stripping. A particularly high level of user comfort can be achieved. Advantageously, an improper stripping of cables can be counteracted particularly reliably.

It is also proposed that an alignment axis of the alignment unit, in particular the alignment axis specified hereinabove, is adjustable relative to the manual machine tool. Advantageously, flexibility of the manual machine tool system may be increased. The machine tool system may be adapted particularly flexibly to different circumstances. Preferably, the alignment axis is adjustable in a plane within an angular range of 360° relative to the manual machine tool. In particular, an alignment of the tool, preferably at least the tool head, relative to the manual machine tool is adjustable.

In addition, a method of operating the tool is proposed. Particularly flexible and/or reliable stripping of cables may be facilitated. A particularly high level of user comfort can be achieved. Advantageously, an improper stripping of cables can be counteracted particularly reliably. In a method step, in particular in a cable insertion step, the cable is preferably inserted into the tool up to the cutting unit, preferably the tool head. In a method step, in particular in an alignment step, the cable is preferably aligned by way of the alignment unit, preferably with respect to the alignment axis. In particular in a method step, preferably in a stripping step, the cable is peeled away until the cable stop is reached. Preferably, a stripped part of the sheath is detached from the cable with a round cut, in particular in a round cut step, preferably after reaching the cable stop. Alternatively, it is conceivable that the stripping step takes place after the round cut step, wherein in particular the cable, in particular in the cable insertion step, is inserted into the tool, preferably the tool head, up to the cable stop.

The tool according to the disclosure, the machine tool system according to the disclosure, and/or the method according to the disclosure should not thereby be limited to the application and embodiment described above. In particular, the tool according to the disclosure, the machine tool system according to the disclosure and/or the method according to the disclosure may have a number of individual elements, components and units that differs from a number specified herein in order to fulfill a function described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. Four exemplary embodiments of the disclosure are shown in the drawing. The drawings, the description, and the claims contain numerous features in combination. A person skilled in the art will appropriately also consider the features individually and combine them into additional advantageous combinations.

The figures show:

FIG. 1 a machine tool system according to the disclosure having a manual machine tool and having a tool according to the disclosure in a perspective view,

FIG. 2 the tool in FIG. 1 in a perspective view,

FIG. 3 the tool of FIG. 1 without an outer housing and with a cable stop in a perspective view,

FIG. 4 a part of the tool of FIGS. 1 to 3 in a perspective view,

FIG. 5a an alignment unit of the tool in a first, particularly open, setting of the alignment unit in a schematic front view,

FIG. 5b the alignment unit of FIG. 5a in a second, particularly closed, setting of the alignment unit in a schematic front view,

FIG. 6a a cutting unit of the tool in a first, in particular an open, setting of the cutting unit in a schematic front view,

FIG. 6b the cutting unit from FIG. 6a in a second, in particular closed, setting of the cutting unit in a schematic front view,

FIG. 7a a cutting element of the cutting unit in a perspective view,

FIG. 7b an alternative configuration for a cutting element of the cutting unit in a perspective view,

FIG. 8 a schematic process of a method for operating the tool,

FIG. 9 a machine tool system according to the disclosure in a first alternative configuration in a perspective view,

FIG. 10 a machine tool system according to the disclosure in a second alternative configuration in a perspective view, and

FIG. 11 a machine tool system according to the disclosure in a third alternative configuration in a perspective view.

### DETAILED DESCRIPTION

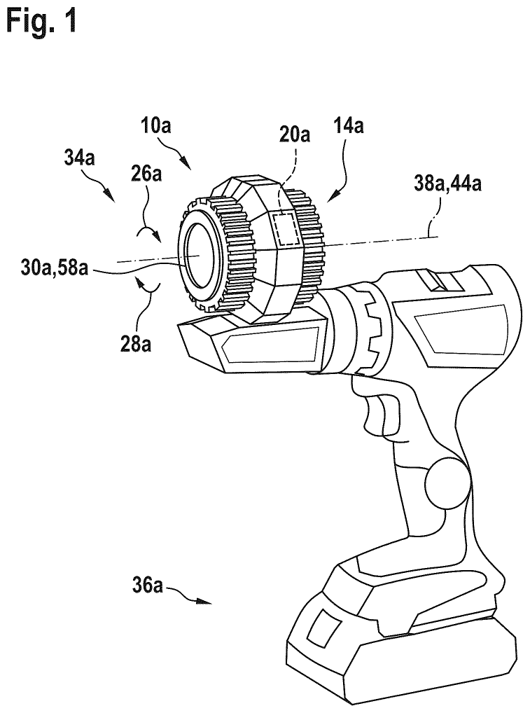

FIG. 1 shows a machine tool system 34a having a manual machine tool 36a and a tool 10a for stripping a cable. The tool 10a is configured as an insertion tool, particularly as an attachment, for the manual machine tool 36a. The tool 10a is attached to the manual machine tool 36a. Alternatively, it is contemplated that the tool 10a may be configured as a stand-alone tool for stripping cables.

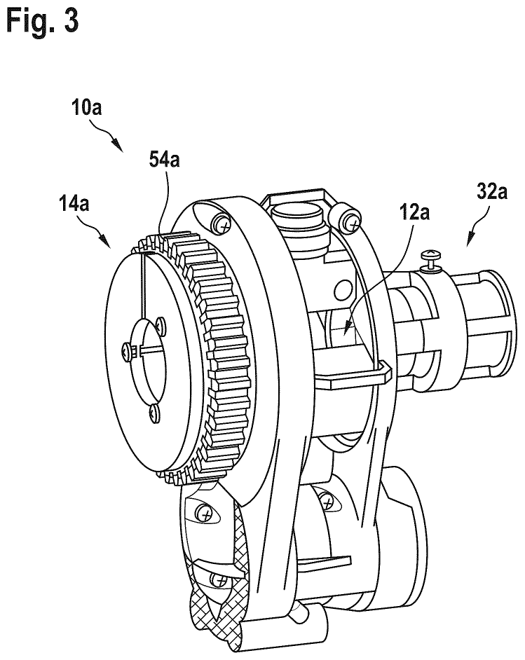

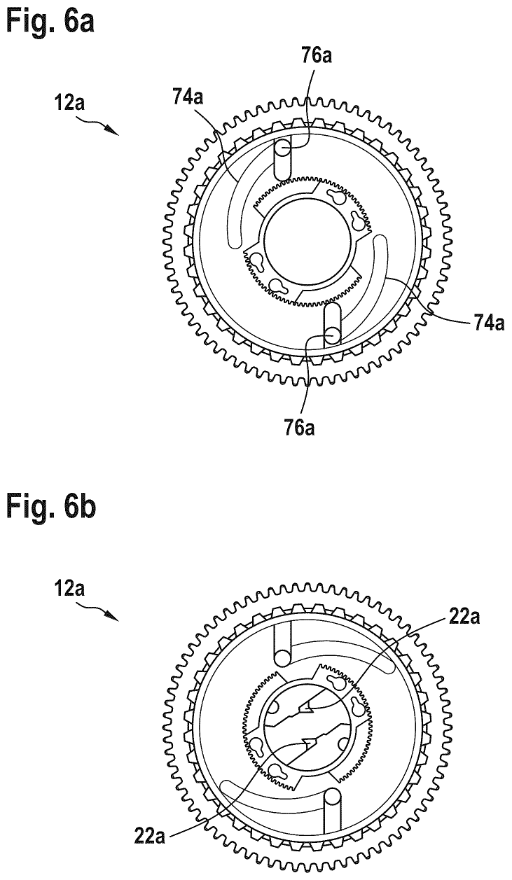

The tool 10a comprises a cutting unit 12a for cutting a sheath of the cable. The tool 10a comprises an alignment unit 14a for aligning the cable for a cutting operation using the cutting unit 12a (cf. FIG. 3). The cutting unit 12a comprises two cutting elements 22a for cutting the sheath (cf. FIG. 6b). Alternatively, it is contemplated that the cutting unit 12a only comprises one cutting element 22a or more than two cutting elements 22a.

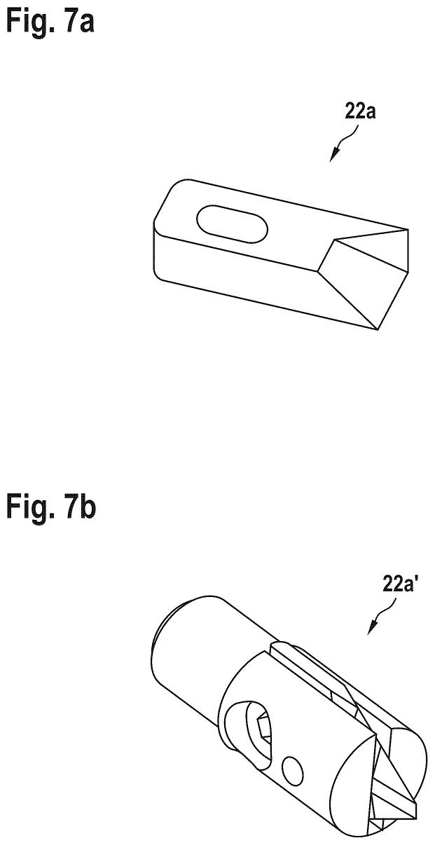

The alignment unit 14a is provided for centering the cable, in particular with respect to the cutting unit 12a. The alignment unit 14a has three alignment elements 42a, by way of example, here. Alternatively, it is also contemplated that the alignment unit 14a has one of three different numbers of alignment elements 42a, for example, only one alignment element 42a, two alignment elements 42a, or more than three alignment elements 42a. The cutting elements 22a are configured herein as planers by way of example (cf. FIG. 7a). Alternatively, however, it is also contemplated that the cutting elements 22a are configured as planers (cf. FIG. 7b).

The tool 10a comprises a base body unit 16a. The alignment unit 14a and the cutting unit 12a are arranged on the base body unit 16a. The base body unit 16a is configured as a housing. The base body unit 16a comprises a tool head 46a. Tool head 46a is tubular. Alternatively, however, it is also conceivable that the tool head 46a is annular in shape or has another shape, in particular a shape different from a tubular shape or an annular shape, which appears to be useful to a person skilled in the art.

The base body unit 16a, in particular the tool head 46a, comprises a receiving area 48a for a cable. The receiving area 48a at least partially abuts the tool head 46a. The receiving area 48a is disposed on an inner side 50a of the tool head 46a. The tool head 46a has a bore 52a, which in particular corresponds to the receiving area 48a. The alignment unit 14a, in particular the alignment elements 42a, and/or the cutting unit 12a, in particular the cutting elements 22a, are disposed on one side of the tool head 46a facing the bore 52a and/or the receiving area 48a.

The cutting unit 12a is adjustable to accommodate different cable diameters. The cutting elements 22a are mounted on the base body unit 16a. The cutting elements 22a are movable relative to the base body unit 16a, preferably for adjusting the cutting unit 12a to accommodate different cable diameters. A minimum distance of the cutting unit 12a, in particular the cutting elements 22a relative to an axis of rotation 44a of the cutting unit 12a and/or alignment axis 38a is adjustable.

The alignment unit 14a is adjustable to accommodate different cable diameters. The alignment elements 42a are mounted on the base body unit 16a. The alignment elements 42a are movable relative to the base body unit 16a, preferably for adjusting the alignment unit 14a to accommodate different cable diameters. The alignment elements 42a are configured as press jaws. The alignment unit 14a, in particular the alignment elements 42a are arranged symmetrically about the alignment axis 38a of the alignment unit 14a. The alignment axis 38a extends at least substantially parallel to the axis of rotation 44a of the cutting unit 12a. The axis of rotation 44a corresponds to the alignment axis 38a.

A minimum distance of the alignment unit 14a, in particular the alignment elements 42a, is adjustable relative to the axis of rotation 44a and/or the alignment axis 38a. The alignment unit 14a is adjustable to a minimum cable diameter of 8 mm, preferably 10 mm, preferably 15 mm. The alignment unit 14a is adjustable to a maximum cable diameter of 60 mm, preferably 120 mm. Alternatively, however, it is also contemplated that the alignment unit 14a may be adjustable to a minimum cable diameter that is less than 10 mm and/or adjustable to a maximum cable diameter that is greater than 120 mm. It is contemplated that the alignment unit 14a may be continuously variable and/or adjustable in stages.

The alignment unit 14a is manually adjustable. For example, the alignment unit 14a includes an alignment setting element 54a for adjustment of the alignment unit 14a by an operator. The alignment setting element 54a is configured herein as a rotating wheel as an example. Alternatively, it is conceivable that the alignment setting element 54a is configured as a button, as a lever, or the like. Alternatively or additionally, it is contemplated that the alignment unit 14a is automatically adjustable, in particular that the alignment unit 14a is provided for a self-adjustment to a cable diameter of a cable.

The tool 10a, in particular the cutting unit 12a and/or the alignment unit 14a, are driven by a drive unit (not shown here) of the hand tool machine 36a, in particular in a state connected with the manual machine tool 36a. The manual machine tool 36a is connectable to the tool 10a, particularly via the drive, via a manual machine tool interface 56a of the tool 10a. Alternatively, it is also contemplated that the tool 10a may include a drive unit to a drive of the cutting unit 12a and/or the alignment unit 14a. The drive unit has, for example, an electric motor or the like.

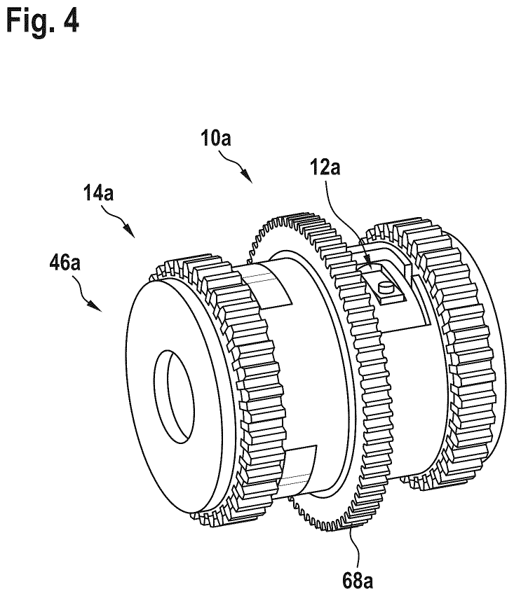

The drive unit is provided to drive the cutting unit 12a about the axis of rotation 44a. The tool head 46a comprises a drive gear 68a (cf. FIG. 4). The drive gear 68a may be driven by the drive unit, in particular to cause a rotation about the axis of rotation 44a. The drive gear 68a is connected to the cutting unit 12a and/or the alignment unit 14a via the drive. In particular, rotation of the drive gear 68a generates rotation of the alignment unit 14a and/or the cutting unit 12a about the axis of rotation 44a, preferably relative to the base body unit 16a, preferably for performing a cutting operation.

An adjustment of the alignment unit 14a is coupled to an adjustment of the cutting unit 12a. The adjustment of the alignment unit 14a is mechanically coupled to the adjustment of the cutting unit 12a. Alternatively, or additionally, it is contemplated that the adjustment of the alignment unit 14a may be electronically, electrically, and/or wirelessly coupled to the adjustment of the cutting unit 12a. The adjustment of the cutting unit 12a is dependent on the adjustment of the alignment unit 14a. By adjusting the alignment unit 14a, an adjustment of the cutting unit 12a can be achieved. Alternatively, however, it is also contemplated that the adjustment of the cutting unit 12a may be movable independent of the adjustment of the alignment unit 14a.

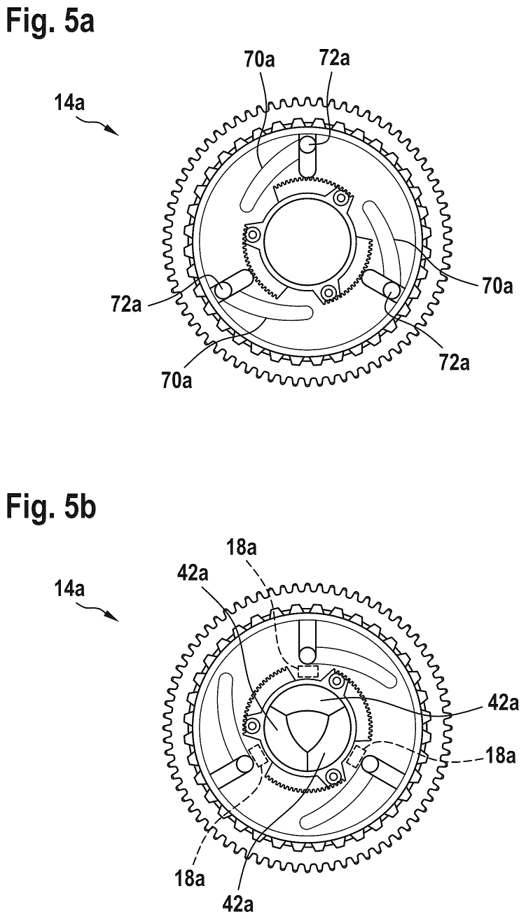

The alignment unit 14a here has three guide tracks 70a, as an example, for guiding guide bolts 72a of the alignment unit 14a (cf. FIG. 5a). The alignment elements 42a are each connected to one of the guide bolts 72a. The alignment unit 14a is adjustable and/or movable by movement of the alignment elements 42a via the guide bolts 72a in the guide tracks 70a, for example, by way of the alignment setting elements 54a.

The cutting unit 12a here has two guide tracks 74a for guiding guide bolts 76a of the cutting unit 12a, for example (cf. FIG. 6a). The cutting elements 22a are each connected to one of the guide bolts 76a. The cutting unit 12a is adjustable and/or movable by moving the cutting elements 22a via the guide bolts 76a in the guide tracks 74a.

The tool 10a comprises a plurality of spring elements 18a, in the example here three, for a spring-mounted alignment of the cable (cf. FIG. 5b). Alternatively, however, it is also contemplated that the tool 10a only comprises one spring element 18a. The spring elements 18a are operatively disposed between one of the alignment elements 42a and the base body unit 16a. The spring elements 18a are configured as springs, in particular as spiral springs, as torsion springs, as leg springs, as leaf springs, as rubber elastic elements or the like. Alternatively or additionally, it is also contemplated that a side facing the alignment elements 42a on one side of the alignment axis 38a, one preferably a further, spring element 18a of the alignment unit 14a is arranged, which preferably abuts the cable in at least one operating state, in particular a cable alignment state.

The tool 10a includes a display unit 20a for displaying an adjustment of the alignment unit 14a. The display unit 20a may be configured as a mechanical indicator, an electromechanical indicator, an electrical indicator, an electronic indicator, or the like, or a combination thereof. The display unit 20a is arranged here, by way of example, on an outer side of the base body unit 16a, in particular the tool head 46a.

A cutting angle of the cutting elements 22a is adjustable. The cutting angle is adjustable, for example, to carry out a spiral, a round and/or longitudinal cut. The cutting angle is adjustable with respect to the alignment axis 38a, in particular movable.

The tool 10a comprises a sensor unit 24a for sensing at least one process characteristic during stripping of the cable. The sensor unit 24a here comprises, by way of example, an accelerometer and/or a gyro sensor. The process characteristic comprises at least one acceleration characteristic. The sensor unit 24a is configured to determine a hazardous situation depending on the process characteristic. For example, the sensor unit 24a is configured to detect a tilting of the cutting unit 12a and/or an unintended rotational movement of the tool 10a depending on the process characteristic, in particular the acceleration characteristic.

It is contemplated that tool 10a may include a control and/or regulation unit (not shown here) for controlling and/or regulating alignment unit 14a and/or cutting unit 12a, particularly the drive unit of the manual machine tool 36a. It is also contemplated that alignment unit 14a and/or cutting unit 12a may be controllable and/or able to be regulated by way of a control and/or regulation unit (not shown here) of the manual machine tool 36a.

It is contemplated that the control and/or regulation unit is provided to control and/or regulate the alignment unit 14a and/or the cutting unit 12a, in particular the power unit, depending on the process characteristic, preferably in a cutting process by the cutting unit 12a and/or in an alignment process by way of the alignment unit 14a. For example, it is contemplated that the control and/or regulation unit is provided to adjust a rotational rate of the cutting unit 12a, switch off the power unit or the like, depending on the process characteristic.

The cutting unit 12a is operable in a soft mode. The soft mode has a soft start. The soft start is active when cutting the sheath using the cutting unit 12a. For example, a rotational rate of the cutting unit 12a in the soft mode, particularly during the soft start, is reduced compared to a normal mode. It is contemplated that a rotational rate of the cutting unit 12a may be continuously increased, preferably continuously or in stages, during the soft start.

The cutting unit 12a is operable in two directions of rotation 26a, 28a. The cutting unit 12a is operable relative to the axis of rotation 44a in two directions of rotation 26a, 28a. The directions of rotation 26a, 28a are opposite to one another. The cutting unit 12a is configured to cut the sheath of the cable in both directions of rotation 26a, 28a.

The cutting unit 12a is configured to produce two different cutting profiles. The cutting unit 12a is configured to produce a first cutting profile in a direction of rotation 26a of the directions of rotation 26a, 28a. The cutting unit 12a is configured to produce a second cutting profile in a further direction 28a of the directions of rotation 26a, 28a, which is opposite to the direction of rotation 26a. The first cutting profile is different from the second cutting profile. The cutting profile can in particular be a round cut, a spiral cut, a longitudinal cut or the like. The first cutting profile is a round cut, for example, here. The second cutting profile is an spiral cut, for example, here.

A cutting element 22a of the two cutting elements 22a is configured and/or arranged such that a cut of the sheath by the cutting element 22a is only carried out in the direction of rotation 26a by a rotation of the cutting unit 12a, preferably relative to the base body unit 16a and/or the cable. A further cutting element 22a of the two cutting elements 22a is configured and/or arranged such that a cut of the sheath by the further cutting element 22a is only carried out in the further direction of rotation 28a by a rotation of the cutting unit 12a, preferably relative to the base body unit 16a and/or the cable. The tool 10a includes an operating element (not shown here) for switching direction of rotation 26a, 28a. The operating element is configured as a button, a lever, a knob, or the like. However, it is also contemplated that the direction of rotation 26a, 28a may be automatically switchable during a cutting operation, for example, by way of the control and/or regulation unit.

The tool 10a comprises a lighting unit 30a to illuminate a cutting area 40a of the cutting unit 12a. The lighting unit 30a here comprises, by way of example, a lighting element 58a. The lighting element 58a is as an LED for example here, in particular an annular LED. Alternatively, it is contemplated that the lighting unit 30a comprises a plurality of lighting elements 58a. The lighting unit 30a is arranged on a side facing the alignment axis 38a of the base body unit 16a, in particular the tool head 46a, preferably on the inner side 50a.

The tool 10a comprises a removable cable stop 32a (cf. FIG. 3). The cable stop 32a is attachable to the base body unit 16a, preferably to the tool head 46a, in such a manner that it can be released. The cable stop 32a is configured to be adjustable. It is contemplated that the cable stop 32a may include a display for reading an adjustment of the cable stop 32a. A maximum stripping distance, in particular parallel to the alignment axis 38a, is adjustable via the cable stop 32a.

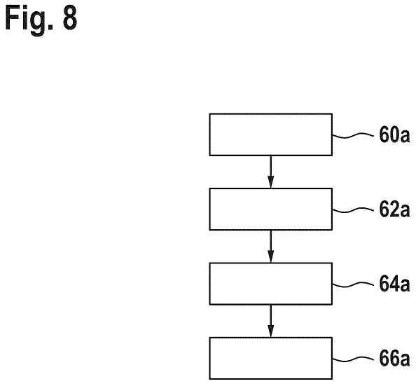

FIG. 8 shows a schematic process of a method for operating the tool 10a. In a method step, in particular in a cable insertion step 60a, the cable is preferably inserted into the tool 10a, preferably the tool head 46a, up to the cutting unit 12a. In a method step, in particular in an alignment step 62a, the cable is aligned by way of the alignment unit 14a, preferably with respect to the alignment axis 38a. In a method step, in particular in a stripping step 64a, the cable is peeled off until the cable stop 32a is reached, preferably by way of the cutting unit 12a, preferably by way of a spiral cut. A stripped portion of the sheath is loosened from the cable, particularly in a round cut step 66a, preferably after reaching cable stop 32a, with a round cut.

Alternatively, it is conceivable that the stripping step 64a takes place after the round cutting step 66a, in particular wherein the cable, in particular in the cable insertion step 60a, is inserted into the tool 10a, preferably the tool head 46a, up to the cable stop 32a.

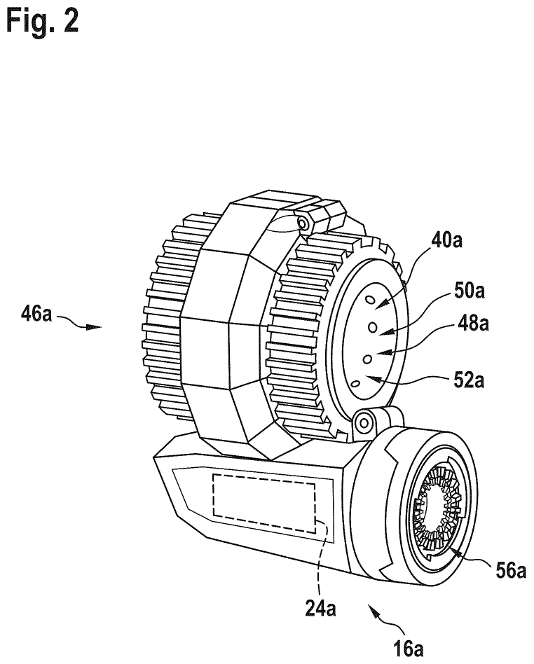

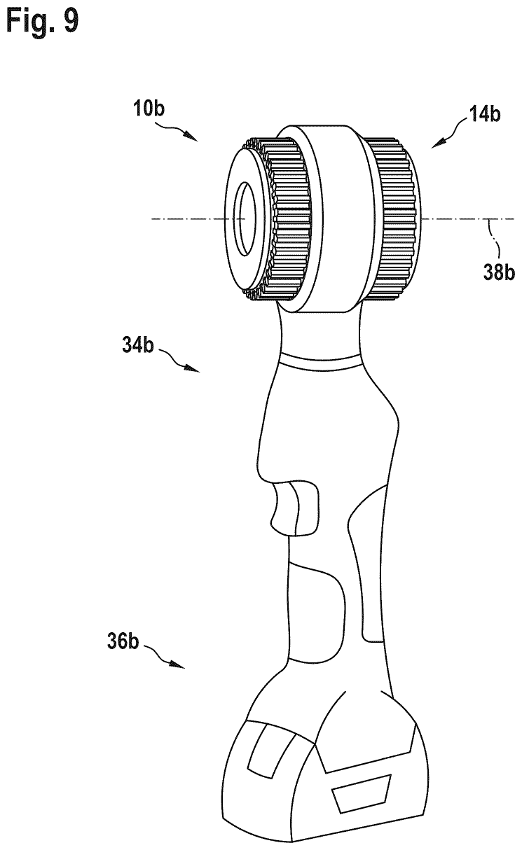

FIGS. 9 through 11 show further exemplary embodiments of the disclosure. The following descriptions and the drawings are substantially limited to the differences between the exemplary embodiments, wherein reference can also be made in principle to the drawings and/or the description of the other exemplary embodiments, in particular FIGS. 1 to 8, with regard to components with the same reference numerals, in particular with regard to components having the same reference signs. To differentiate between the exemplary embodiments, the letter a is placed after the reference numerals of the exemplary embodiment in FIGS. 1 to 8. In the exemplary embodiments of FIGS. 9 through 11, the letter a is replaced by letters b to d.

FIG. 9 shows a machine tool system 34b having a manual machine tool 36b and a tool 10b. The tool 10b is attached to the manual machine tool 36b. An alignment axis 38b of an alignment unit 14b of tool 10b is adjustable relative to the manual machine tool 36b. The alignment axis 38b is adjustable in a plane within a range of 360° relative to the manual machine tool 36b. An alignment of the tool 10b is adjustable relative to the manual machine tool 36b.

The alignment axis 38b is at least substantially perpendicular to a main extension axis of the manual machine tool 36b. A “main extension axis” of an object can be understood in particular as an axis that extends parallel to a longest edge of a smallest geometric cuboid that just completely encloses the object, and in particular extends through the center of the cuboid. The term “substantially perpendicular” can be understood to mean an alignment of a direction relative to a reference direction, wherein, in particular viewed in a projection plane, the direction and the reference direction enclose an angle of 90° and the angle has a maximum deviation of in particular less than 8°, advantageously less than 5°, and particularly advantageously less than 2°.

The plane is disposed at least substantially perpendicular to the main extension axis of the manual machine tool 36b. The tool 10b is disposed in extension of the manual machine tool 36b with respect to the main extension axis of the manual machine tool 36b.

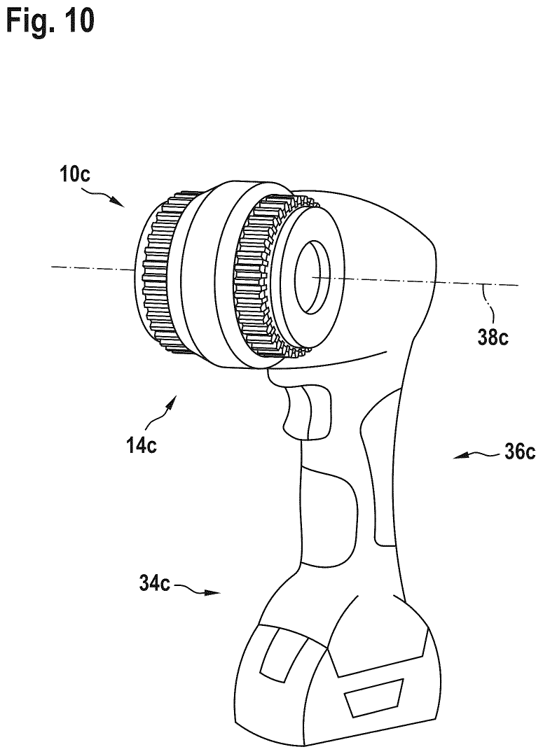

FIG. 10 shows a machine tool system 34c having a manual machine tool 36c and a tool 10c. The tool 10c is attached to the manual machine tool 36c. An alignment axis 38c of an alignment unit 14c of tool 10c is adjustable relative to the manual machine tool 36c. The alignment axis 38c is adjustable in a plane that is at least substantially parallel to a main extension axis of the manual machine tool 36c.

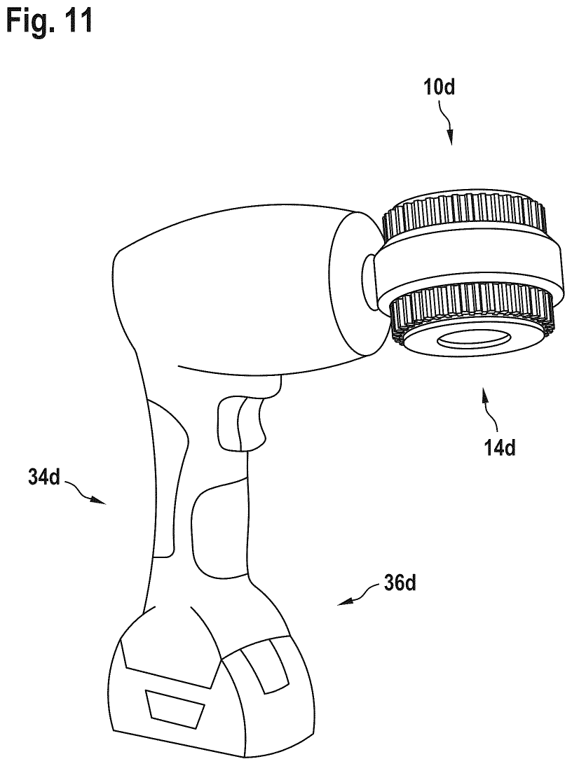

FIG. 11 shows a machine tool system 34d having a manual machine tool 36d and a tool 10d. The tool 10d is attached to the manual machine tool 36d. An alignment axis 38d of an alignment unit 14d of tool 10d is adjustable relative to the manual machine tool 36d.

What is claimed is:

1. A tool for stripping a cable, comprising:
a cutting unit configured to cut a sheath of the cable;
an alignment unit configured to align the cable for a cutting operation by way of the cutting unit; and
a base body unit on which the alignment unit and the cutting unit are arranged,
wherein the alignment unit is configured to be adjustable so as to accommodate different cable diameters.

2. The tool according to claim 1, wherein an adjustment of the alignment unit is coupled to an adjustment of the cutting unit.

3. The tool according to claim 1, wherein the alignment unit is configured for self-adjustment to a cable diameter of a cable.

4. The tool according to claim 1, further comprising at least one spring element, wherein the alignment unit is at least partially connected to the base body unit via the spring element.

5. The tool according to claim 1, further comprising a display unit configured to display an adjustment of the alignment unit.

6. The tool according to claim 1, wherein the cutting unit includes at least one cutting element with an adjustable cutting angle.

7. The tool according to claim 1, further comprising a sensor unit configured to sense at least one process characteristic during stripping of the cable.

8. The tool according to claim 1, wherein the cutting unit is configured to operate in a soft mode.

9. The tool according to claim 1, wherein the cutting unit is configured to operate in two directions of rotation.

10. The tool according to claim 9, wherein the cutting unit is configured to produce two different cutting profiles.

11. The tool according to claim 1, further comprising a lighting unit configured to illuminate a cutting area of the cutting unit.

12. The tool according to claim 1, further comprising a removable cable stop.

13. A machine tool system, comprising:
a manual machine tool; and
a tool according to claim 1, wherein the tool is configured to be attached to the manual machine tool.

14. The machine tool system of claim 13, wherein an alignment axis of the alignment unit is adjustable relative to the manual machine tool.

15. A method for operating a tool according to claim 1.
